(19) United States
(12) Patent Application Publication
(10) Pub. No.: US 2024/0013488 A1
(43) Pub. Date: Jan. 11, 2024

(54) Groups and Social In Artificial Reality

(71) Applicant: Meta Platforms Technologies, LLC, Menlo Park, CA (US)

(72) Inventors: Clint BEHARRY, San Francisco, CA (US); Yonglong ZHANG, Freemont, CA (US); Demetrius ELLINGSON, Berkeley, CA (US); Yukai YANG, Seattle, WA (US); Chang LIU, Fremont, CA (US); Harini CHANDRASEKAR, Seattle, WA (US); Rachel CROSS, Foster City, CA (US); Patricia DOOLEY, Bothell, WA (US); Sharon KOJIMA, San Jose, CA (US)

(21) Appl. No.: 18/448,199

(22) Filed: Aug. 11, 2023

Related U.S. Application Data
(60) Provisional application No. 63/373,262, filed on Aug. 23, 2022.
(60) Provisional application No. 63/373,259, filed on Aug. 23, 2022.
(60) Provisional application No. 63/371,342, filed on Aug. 12, 2022.

(51) Int. Cl. G06T 19/00; G06T 13/20; G06T 13/40

(52) U.S. Cl. CPC G06T 19/00; G06T 13/205; G06T 13/40; G06T 2219/024; G06F 3/017

(57) ABSTRACT

In some implementations, the disclosed systems and methods can implement dynamic presentation controls in virtual reality environments. In some implementations, the disclosed systems and methods can customize the activity based on the state e.g., by setting corresponding visual indicators (changing colors, adding 3D models or effects to the artificial reality environment, showing words or emoticons, etc.), changing sound qualities (volume, tempo, applying effects, etc.), supplying haptic feedbacks to the group participants, etc. In some implementations, the disclosed systems and methods can provide groups of artificial reality users (which may be split into opposing teams) common goals to achieve, can monitor user activities toward those goals, and can provide status indicators for progress toward the goals.

### CROSS REFERENCE TO RELATED APPLICATIONS

This application claims priority to U.S. Provisional Application Numbers 63/371,342 filed Aug. 12, 2022 and titled “Dynamic Presentation Controls in Environments,” 63/373,262 filed Aug. 23, 2022, and titled “Artificial Reality Group Activities Based on Group State,” and 63/373,259 filed Aug. 23, 2022 and titled “Artificial Reality Group Activities.” Each patent application listed above is incorporated herein by reference in their entireties.

### BACKGROUND

Artificial/virtual reality devices are becoming more prevalent and offer great scope for enhancing presentations such as lectures, discussion shows, and artistic performances. The VR environment supports video, audio, animation, exhibits, and other virtual objects that, when combined, can create more interesting developments of the subject matter and almost magical effects to enhance the audience's understanding and enjoyment. As more and more of these presentations and events are being designed for presentation in the metaverse, tools must be developed to support the creation of these experiences.

Artificial reality (XR) devices such as head-mounted displays (e.g., smart glasses, VR/AR headsets), mobile devices (e.g., smartphones, tablets), projection systems, “cave” systems, or other computing systems can present an artificial reality environment where users can interact with “virtual objects” (i.e., computer-generated object representations) appearing in an artificial reality environment. These artificial reality systems can track user movements and translate them into interactions with the virtual objects. For example, an artificial reality system can track a user's hands, translating a grab gesture as picking up a virtual object.

### SUMMARY

Aspects of the present disclosure are directed to a method for implementing dynamic presentation controls in virtual reality environments. The method includes detecting a trigger in a presentation and, in response to detecting the trigger, initiating a corresponding event within the presentation to make a pre-configured world change within the virtual reality embodiment. The trigger may be, but is not limited to, a time within the presentation, a user movement, a spoken command, a UI activation, etc. The event may be virtually anything that can be presented within a specific world of the VR environment, by or under the control of an avatar or presenter.

Additional aspects of the present disclosure are directed to a group activity system that facilitates activities for groups of users in an artificial reality environment, where the activities are customized based on a determined state of the group. The state of the group can be in various categories such as emotional level, sound level or tempo, common actions, sentiments expressed by the group, etc. In various implementations, the group activity system can customize the activity based on the state e.g., by setting corresponding visual indicators (changing colors, adding 3D models or effects to the artificial reality environment, showing words or emoticons, etc.), changing sound qualities (volume, tempo, applying effects, etc.), supplying haptic feedbacks to the group participants, etc.

Further aspects of the present disclosure are directed to providing activities with a common goal to a group of users in artificial reality. In-person events often have group activities that attendees join to foster a sense of community and cooperation. However, organizing such activities in an artificial reality environment has been harder to achieve as user interactions are more difficult to direct, track, and implement. The disclosed group activity system can provide groups of artificial reality users (which may be split into opposing teams) common goals to achieve, can monitor user activities toward those goals, and can provide status indicators for progress toward the goals. For example, virtual attendees at a basketball game can, during halftime, be split into two teams and throw virtual basketballs at the hoops from the attendees' seats. The group activity system can track the relative scores of the two teams and display them, via the user's artificial reality devices.

### BRIEF DESCRIPTION OF THE DRAWINGS

FIG. 1 is a first exemplary view into a virtual reality (VR) environment in which a speaker is making a presentation to an audience.

FIG. 2 is a second exemplary view into a VR environment in which a speaker, who is making a presentation to an audience, triggers a pre-configured world change event within the VR environment.

FIG. 3 is a third exemplary view into a VR environment in which two speakers are making a joint presentation to an audience.

FIG. 4 is a flow diagram illustrating a process for implementing dynamic presentation controls in a VR environment.

FIG. 5 is a conceptual diagram of a virtual sporting event where a group performing a wave action caused a corresponding fireworks customization.

FIG. 6 is a conceptual diagram of a virtual concert where determined group energy and emotion levels caused a corresponding emojis customization.

FIG. 7 is a conceptual diagram of a virtual conference where a group providing ideas caused a corresponding word cloud customization.

FIG. 8 is a flow diagram illustrating a process used in some implementations for providing customizations in response to a determined state of a group participating in an artificial reality environment activity.

FIG. 9 is a conceptual diagram of an example of first collaborative artificial reality group activity.

FIG. 10 is a conceptual diagram of an example of a second collaborative artificial reality group activity.

FIG. 11 is a conceptual diagram of an example of a competitive artificial reality group activity.

FIG. 12 is a flow diagram illustrating a process used in some implementations for providing activities with a common goal to a group of users in artificial reality.

FIG. 13 is a block diagram illustrating an overview of devices on which some implementations of the present technology can operate.

FIG. 14 is a block diagram illustrating an overview of an environment in which some implementations of the present technology can operate.

### DESCRIPTION

Methods and systems are provided to implement, in a virtual reality (VR) environment, triggering of events that cause pre-configured world changes. For example, an event such as the creation, modification, movement, or disappearance of a virtual object can be triggered according to a timed schedule or by an action or word of a presenter. For example a presenter could say the word “dog,” and a pre-configured image of a dog would appear next to the presenter.

The events can be virtually anything that can be presented within a specific world of the VR environment, such as events by or under the control of an avatar or presenter. The events can be the display of a virtual object or anything related to such a virtual object. The events can be derived from the real world, such as a news broadcast, or can be drawn from the wildest expressions of imagination. The events can be images, sounds, or anything else that can be envisioned to explain, supplement, or enhance a presentation. Doors can open into previously hidden areas, story lines can be developed based on suggestions from a variety of sources, and interactions between avatars or between avatars and virtual objects can be choreographed. Fundamentally, an event is anything that can be presented to cause a world change within the VR environment. The events in any specific world are pre-configured to operate in that world, but such events are unlimited in that specific world only by the creativity of the world's producer.

Correspondingly, each event will have a respective trigger to cause the event to occur, but the possible triggers are again virtually unlimited. Examples of triggers include a word spoken or a gesture made by a presenter. A combination of such words and/or gestures may be used as a trigger, for example, a magician saying “Presto!” and then snapping his fingers. A trigger may be defined, for example, as a certain time within the presentation, or a certain time within the presentation when combined with one or more other triggers such as words or gestures, or as a certain time within a video that appears within the presentation. The timing could be set by reference to a server clock or other timing element. Further examples include other user actions, or avatar actions such as pressing a virtual button or interacting with another virtual person or other virtual object. The definition of a trigger is not limited by these examples. However, the trigger must have a defined pre-configured event (or plural such pre-configured events) associated therewith to be actualized upon the occurrence of the trigger.

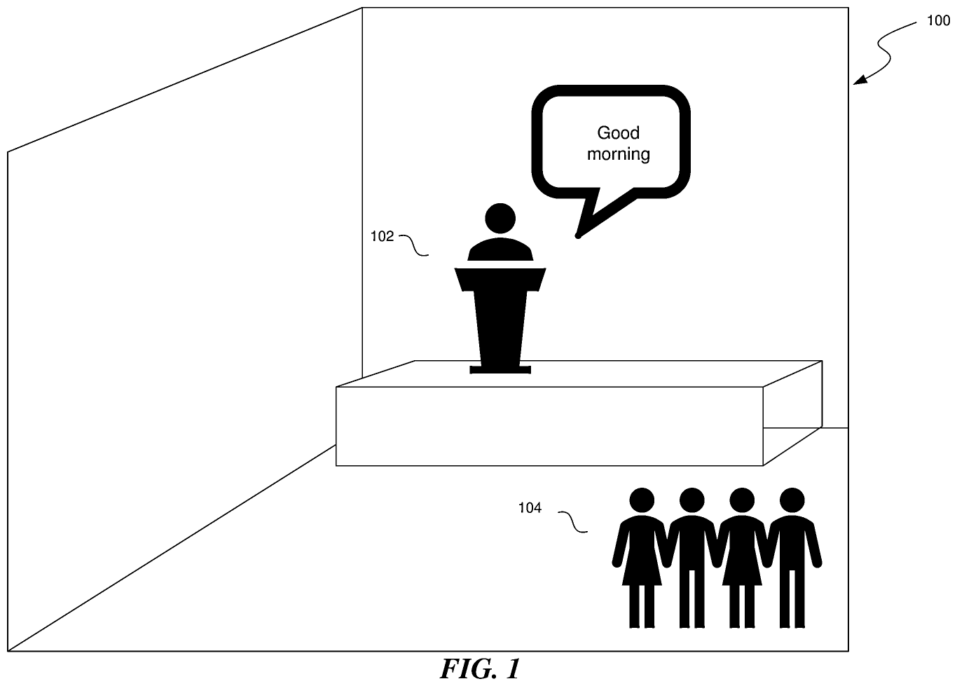

FIG. 1 is an exemplary view 100 into a VR environment in which a speaker 102 is making a presentation. The view 100 also includes an audience 104 that can be passive or may be capable of response to the speaker 102 during the presentation. In this example, the people are represented by avatars, but the speaker 102 and/or audience 104 may presented by, e.g., holograms, video, etc. In FIG. 1, the speaker 102 has just spoken the words “Good morning,” but these words have not been established as a trigger for any event.

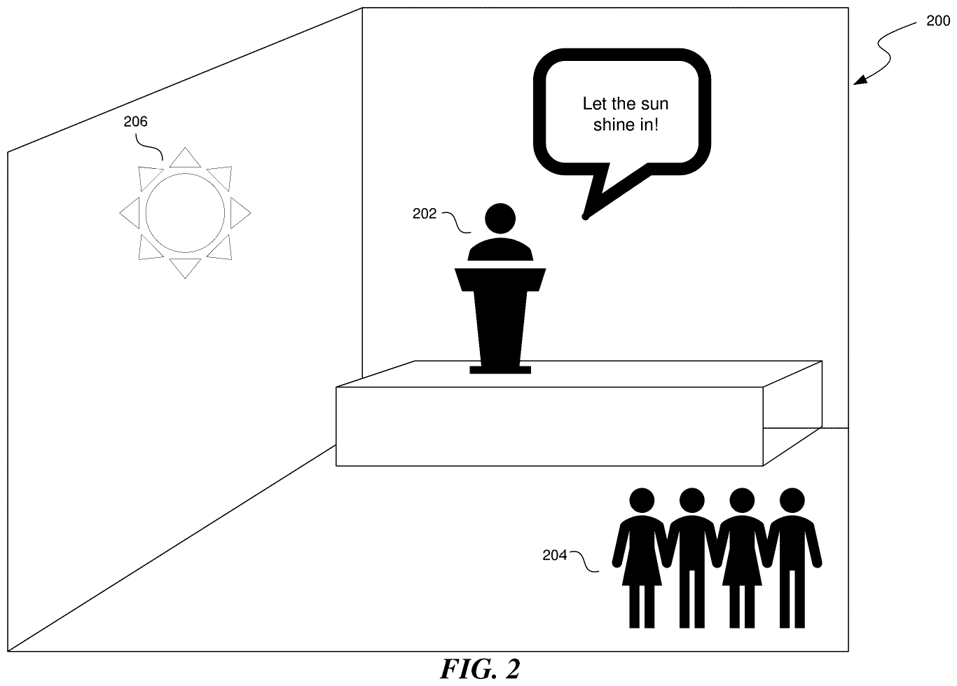

FIG. 2 is an exemplary view 200 into a VR environment in which a speaker 202 is making a presentation to an audience 204. In FIG. 2, the speaker 202 has just spoken the words “Let the sun shine in!” which was previously established as a trigger for the an event in which an model 208 of a shining sun appears next to the speaker 202.

The triggers for the events, and the events themselves, can be incorporated into different types of presentations in many ways. In some implementations, the presentation may be pre-recorded, with the events to be added later. In such cases, the creator of the presentation knows exactly when an event should be triggered, and can therefore define the trigger to be a specific time within the presentation. Equally in such cases, the creator knows exactly when an incident happened in the presentation (e.g., something the presenter said or did) just before the moment when the event should be triggered, and can therefore define the trigger to be that incident. In the recording, the event looks as if it is presented in response to an incident, e.g., the words of the presenter, but in fact both the trigger and the event are pre-planned.

In some implementations, the presentation may be pre-recorded, but the events are added in during the recording of the presentation. In such cases, the creator of the presentation determines ahead of time what events are to be triggered during the presentation, and prepares both the triggers and the respective events. For example, the creator determines ahead of time that the presenter will say “Let the sun shine in,” and will have the image of the sun automatically added in at that time. Here again, in the recording, the event looks as if it is presented in response to the user action, e.g., the words of the presenter, but the trigger and the event are pre-planned according to a timed schedule.

In some implementations, the presentation may be live, but the events are still pre-planned. For example, a comedian (i.e., the presenter) may be performing a live act that is being recorded. The comedian may ask the audience “where are you from?” An audience member may call out “Los Angeles,” and an image of the sun may appear, e.g., either automatically in response to the words, or in response to the comedian making a gesture. If an audience member calls out “San Francisco,” an image of rain may appear, e.g., again either automatically in response to the words, or in response to the comedian making a different gesture or pushing a button. During a live act, the actor can prepare quick responses to audience inputs to make the events appear to happen spontaneously. Moreover, in the recording, the event looks as if it is presented in response to an incident, i.e., the audience participation, but in fact the different triggers and the respective events are pre-planned.

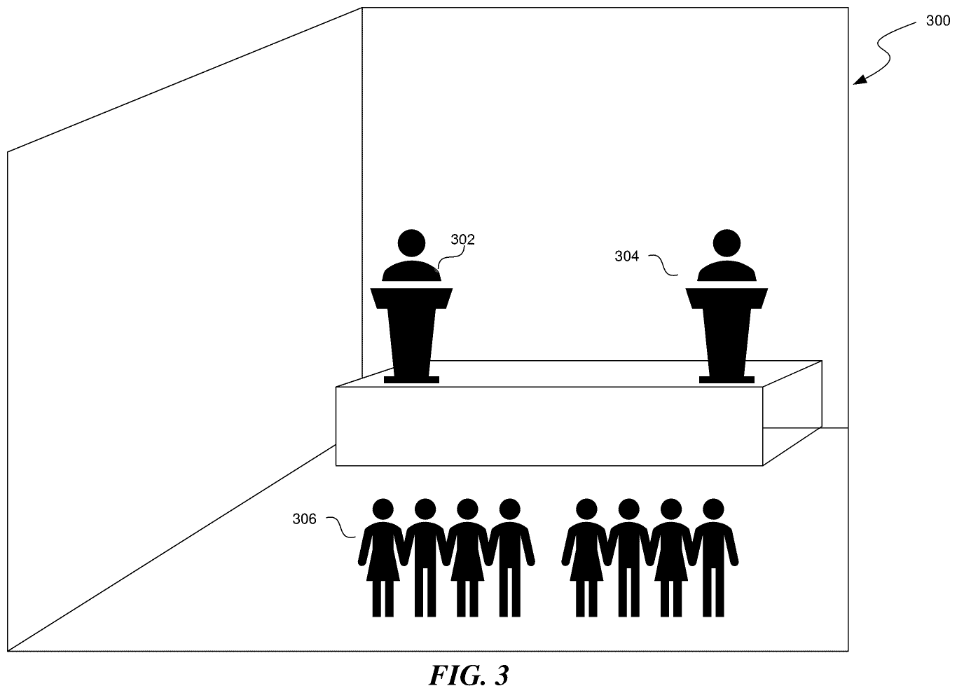

FIG. 3 is an exemplary view 300 into a VR environment in which two speaker avatars 302, 304 are making a joint presentation to an audience 306. The two avatars 302, 304 may be generated from two speakers recorded together to generate the scene, or the two avatars may be generated separately and then composited into the scene. Additional avatars may be added to create additional interactions. Each avatar can be recorded from a separate speaker, or the same speaker can be sequentially used for two or more such avatars. Being able to composite avatars enables a multi-avatar coordination system in which each avatar can be independently controlled. For example, a scene may start with only one avatar, and then others may join later at respective times specified by a system clock. Groups of two or more avatars can also be recorded together, and then the individual avatars and/or groups of avatars can be composited in the scene. Any supporting files, such as animation files and audio files, can be uploaded for each avatar in the backend. The avatars may move or speak in unison or separately. Each of the avatars may have an individual movement pattern, and triggers can be derived from one or more of the avatars as they move to different positions or take different attitudes with respect to other avatars or virtual objects.

The ability to composite an avatar into a scene provides a further implementation for presentations to large audiences. A VR presentation may be made to an audience of hundreds of people or more, and it is therefore difficult or impossible to represent each viewer by an individualized avatar, such as an avatar having a readable name. Accordingly, one or more speaker avatars can be provided and live-casted into plural instances of the presentation. A maximum number of viewers can be set for each instance so as not to exceed the capacity of the system, and then the same presentation is given in each instance. In this way, the viewer avatars can be represented.

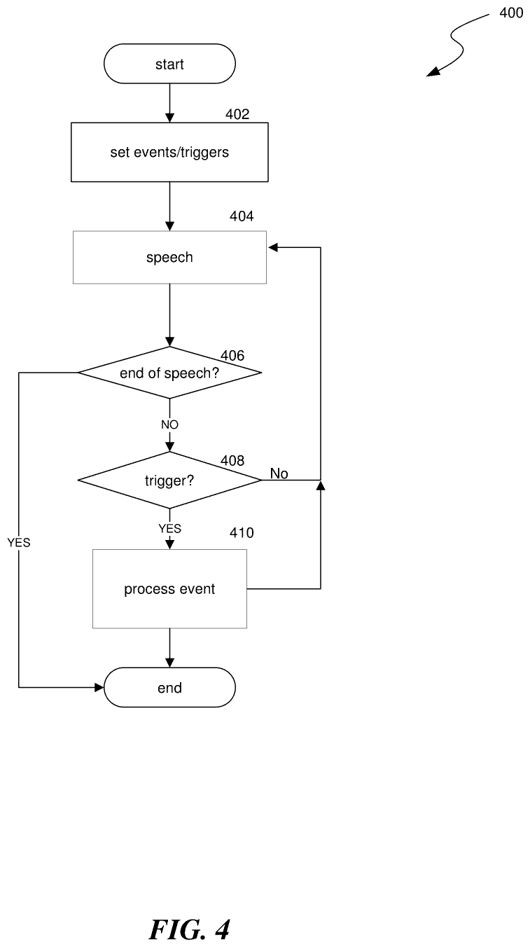

FIG. 4 is a flow diagram illustrating a process 400 for implementing dynamic presentation controls in a virtual reality environment. In the implementation shown in FIG. 4, a speech has been pre-recorded and is to be presented using defined triggers as dynamic controls to initiate events that cause pre-configured world changes.

In step 402, process 400 analyzes the pre-recorded speech to determine where and when specific events in the presentation are to be triggered, and further what trigger is to be used for each such event. As described above, the content and nature of the events themselves are basically limited only by the imagination of the designer. The triggers may be specific times during the presentation, set by reference to, e.g., a server clock, or may be certain words or gestures, or any other possibilities that can be recognized by the system to function as triggers.

In step 404, process 400 begins/continues production of the speech. As this production continues, in step 406, process 400 can determine whether the speech has ended. If the speech is continuing production, in step 408, process 400 can determine whether a trigger has been detected. The detection of a trigger depends on the nature of the trigger, e.g., a time trigger can be detected from the server clock, a word can be detected by a speech input module configured for natural language processing, a user can interact with a UI element as a trigger, a gesture can be detected by a movement input module configured with computer vision to analyze a user's body pose and match it to pre-defined poses such as hand gestures, sitting/standing poses, or other movements, etc. In some implementations, the viewer is unaware that a trigger has occurred, e.g., when the trigger is a detected time in the speech. In other implementations, the viewer may be aware of the existence of the trigger, e.g., the viewer may hear the word or see the gesture, but the viewer is unaware of the significance of the trigger in initiating the event. Accordingly, when the event is then immediately presented, it appears to the viewer to have been spontaneously created.

In step 410, process 400 can present the event that is associated with the detected trigger. For example, process 400 can cause an effect to run, display or hide a virtual object, play a sound, cause a haptic output, initiate a communication with a server or other third-party system, etc. Then process 400 returns to step 404 to continue production of the speech, including any subsequent triggers and associated events.

It will be understood that in other types of presentations, the generation and detection of triggers may be differently implemented. For example, in a live-casting presentation, some of the events may be pre-configured, but the corresponding triggers are inserted into the presentation as it progresses. For example, in the case of a comedian who has an audience member shout out “I'm from Los Angeles” or “I'm from SanFrancisco,” it is unknown ahead of time what city will be announced. The two events (sun or rain) are pre-configured and ready to go, but it is unknown which shout-out will occur. In this case, it may be that the trigger is not determined upon review of the recorded presentation, but that the trigger is the content of the shout-out itself. In another example, the comedian may have several effects prepared ahead of time, and may trigger a selected event by, e.g., pushing a corresponding button during the live-casting. Here again, the trigger and event may be determined during the live-casting, rather than during a retrospective review of the recording.

Aspects of the present disclosure are directed to a group activity system that provides customizations (e.g., visual, auditory, and/or haptic) in response to a determined state of a group participating in an artificial reality environment activity. The customizations can be, for example, adding a virtual object to the artificial reality environment, causing an existing virtual object to move in a particular way, adding an effect to the artificial reality environment, changing a property of audio associated with the artificial reality environment, sending haptic feedback to one or more of the group participants, etc. For example, the group activity system can apply coloring or shading to an environment, add virtual objects such as fireworks, streamers, or emoji icons, change the beat or volume of music, send vibrations through a controller or mobile phone, etc.

In various implementations, the group activity system can determine different types of group states such as user energy level, emotional state, or activity; content of user submissions; noise level; associations between users or users and objects; etc. In various implementations, the group state can be determined based on directly monitoring user activities (e.g., via cameras directed at the user, wearable devices, etc.) or by monitoring the activities of avatars in the artificial reality environment controlled by users. In some cases, machine learning models or rules can be applied to map user properties (e.g., actions, noise, multiple user interactions, etc.) to higher-order states such as emotional content or energy level.

The group activity system can further apply rules that map various determined states to artificial reality environment customizations. As examples, a rule can define that streamers should be shown when everyone in a room yells “surprise,” another rule can define that a color shading applied to ambient lighting at a concert should change according to the beat of the music being played, and a third rule can define that a giant scale should appear over a crowd and be weighted according to the percentage of the crowd who raise their hands.

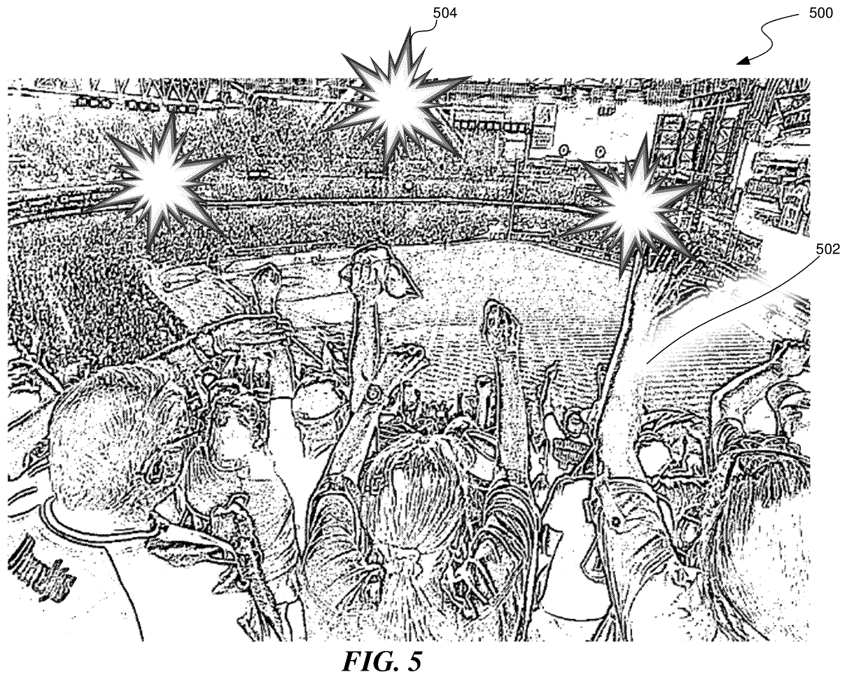

FIG. 5 is a conceptual diagram of example 500 for a virtual sporting event where a group performing a wave action caused a corresponding fireworks customization. In example 500, the users attending the virtual sporting event are represented by avatars such as avatar 502. As the users control their avatars to perform “the wave,” the group activity system recognizes, based on a rule monitoring for avatars that stand and raise their hands in succession around the arena, that the wave is being performed. In response, the group activity system adds virtual objects showing fireworks, such as virtual object 504, to the artificial reality environment.

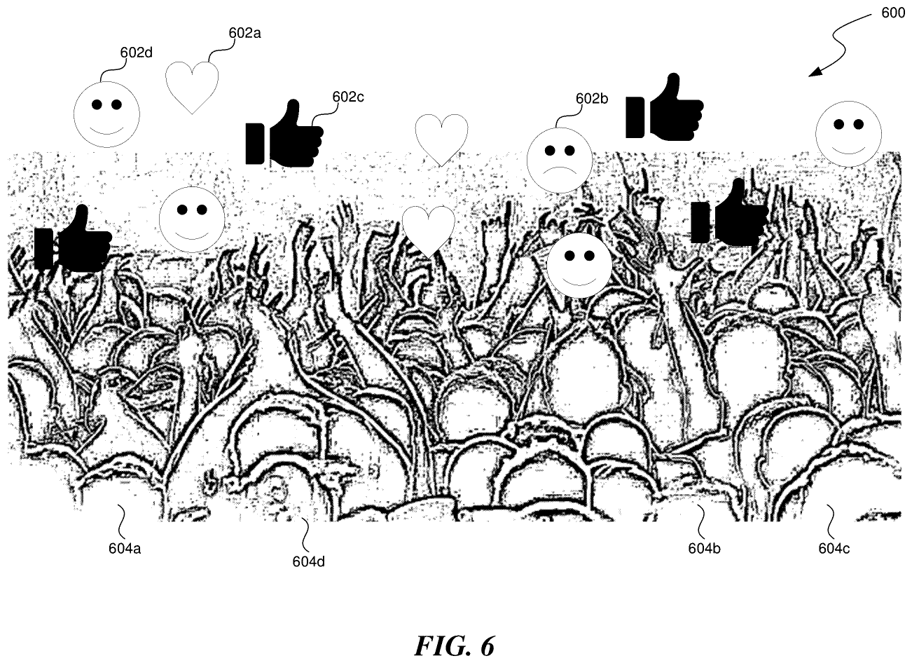

FIG. 6 is a conceptual diagram of example 600 for a virtual concert where determined group energy and emotion levels caused a corresponding emojis customization. In example 600, the users attending the virtual concert are represented by avatars such as avatars 604a-d. As the users control their avatars to put their hands up, yell and sing along, dance, clap, etc. the group activity system recognizes, based on a rule monitoring for levels of these activities, various emotional states in the crowd. In response, the group activity system adds virtual objects showing emojis, such as virtual objects 602a-d, to the artificial reality environment.

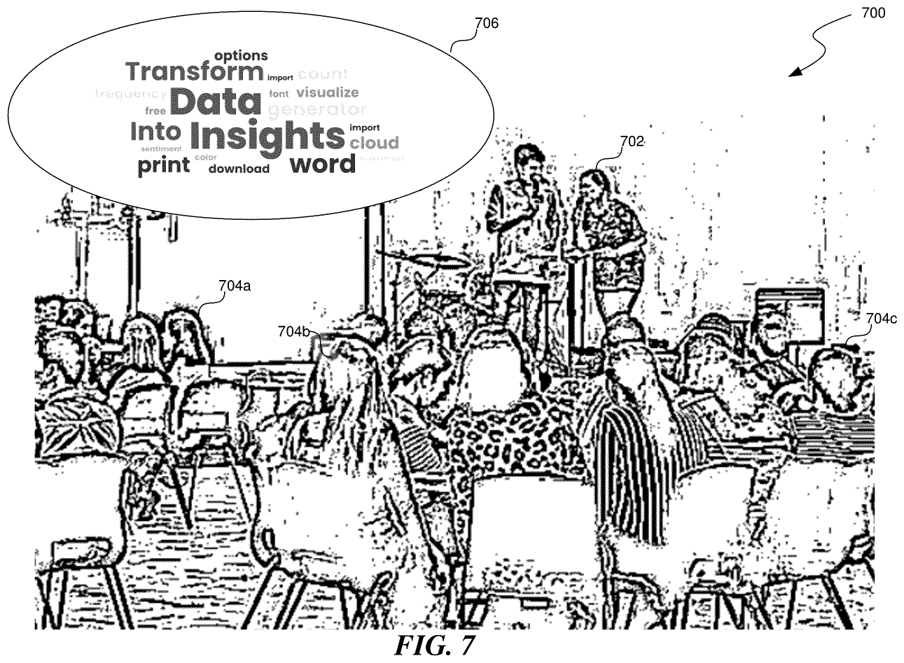

FIG. 7 is a conceptual diagram of example 700 for a virtual conference where a group providing ideas caused a corresponding word cloud customization. In example 700, the users attending the virtual conference are represented by holograms such as hologram 704a-c. The holograms move according to the movements of the users. Further in example 700, a presenter 702 has provided instructions for each attendee to submit three words to a virtual form provided by the users' artificial reality devices (not shown). In response, the group activity system adds a virtual object 706 showing a word cloud of the submitted words.

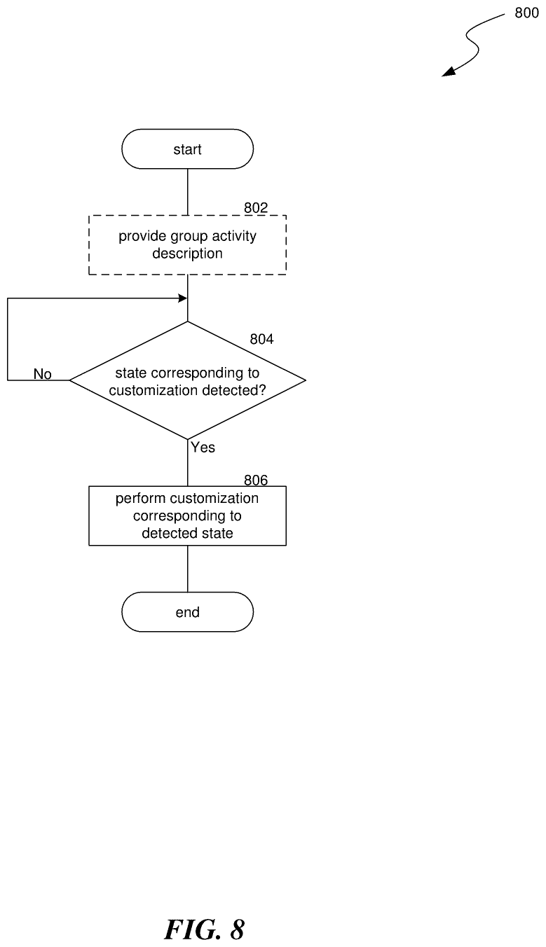

FIG. 8 is a flow diagram illustrating a process 800 used in some implementations for providing customizations in response to a determined state of a group participating in an artificial reality environment activity. In some implementations, process 800 can be performed on an artificial reality environment or by a server supporting such a device. In some implementations, process 800 can be performed as part of an application in control of an artificial reality environment, e.g., when the artificial reality environment is executed.

While any block can be removed or rearranged in various implementations, block 802 is shown in dashed lines to indicate there are specific instances where block 802 is skipped. At block 802, process 800 can provide a group activity description. For example, process 800 can provide instructions to perform a particular activity, e.g., by one or more of: instructing the users on an action to perform, telling the users how actions map to customizations, identifying which users are opting in/out of the activity, etc. In some cases, process 800 can facilitate these instructions via, e.g., notifications in the display of the users' artificial reality devices, a non-player character (NPC) avatar, augments to the users' avatars (e.g., team colors/uniforms), etc.

At block 804, process 800 can determine whether a group state corresponding to an artificial reality environment customization is present. In various implementations, users can perform activities e.g., by puppeting their artificial reality avatars with their real-world movements (tracked by their artificial reality device); by providing control instructions through a touch display, controller, mouse, or keyboard; though voice commands; etc. Process 800 can have established rules to determine when user activities (either alone or in combination with other user activities) match a defined customization. For example, where the customization is to add a green tint to everything, process 800 can monitor for when all the participants in a conference shout “show me the money!” In various implementations, the rules can monitor for physical activities of the users (e.g., moving their hands, making facial expressions, speaking, etc.), activities of the avatars controlled by the users, or interactions between the avatars and other avatars and/or real or virtual objects. In some cases, the rules can further or instead be based on a context the users are in, as opposed to express activities of the users, e.g., a sound of the music at a concert, a point in a show, etc.

At block 806, process 800 can perform the customization corresponding to the detected state. This can be accomplished by executing a rule that implements the customization corresponding to the state detected at block 804. While the customization can be any change to the artificial reality environment or output for the users, examples include adding virtual objects to the artificial reality environment, adding an effect, setting colors or shading, changing a feature of the audio output, supplying haptic feedback to the users, etc. Process 800 can then end (or can be re-executed by the application in control of the artificial reality environment).

Aspects of the present disclosure are directed to a group activity system that provides activities with a common goal to a group of users in artificial reality. In some cases, group activity system is part of a virtual event, such as a virtual concert, sporting event, social gathering, work meeting, etc., taking place in an artificial reality environment. Users attending the event can participant via their artificial reality device—e.g., virtual reality (VR) headset, mobile device providing an augmented reality passthrough, mixed reality headset, etc. The group activity system can facilitate the group activity by initially providing instructions to the group of users or otherwise organizing the group of users to perform the activity. The group activity system can then monitor user activities as they attempt the group activity, progressing toward an objective for the activity. Finally, the group activity system can provide results to the group, indicating their progress toward the objective.

In various implementations, the group activity system can initially provide instructions to perform the activity, e.g., by one or more of: instructing the users on the group goal, organizing the users into teams, identifying which users are opting in/out of the activity, etc. In some cases, the group activity system can facilitate these instructions via, e.g., notifications in the display of the users' artificial reality devices, a non-player character (NPC) avatar, augments to the users' avatars (e.g., team colors/uniforms), etc.

The group activity system can monitor user activities as they attempt the group activity, progressing toward an objective for the activity. In various implementations, users can perform activities e.g., by puppeting their artificial reality avatars with their real-world movements (tracked by their artificial reality device); by providing control instructions through a touch display, controller, mouse, or keyboard; though voice commands, etc. For any given goal, the group activity system can have established rules to determine when user activities (either alone or in combination with other user activities) progress the goal. For example, where the goal is “as many users as possible holding hands,” the group activity system can count the number of avatars that have touching hands at any given time.

The group activity system can provide results to the group, e.g., as the activities progress or once milestones are reached. Depending on the defined rules for the group activity, the group activity system can, for example, provide a score counter (overall or per-team), an indicator when a goal is reached, a progress bar toward the goal, emojis or other graphics corresponding to progress or group characteristics, etc.

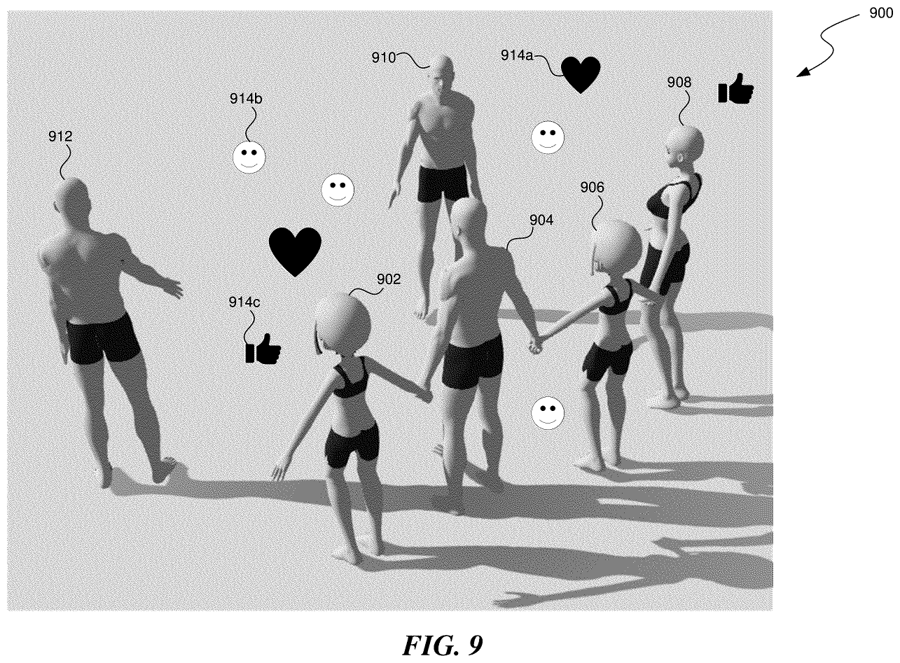

FIG. 9 is a conceptual diagram of an example 900 of first collaborative artificial reality group activity. FIG. 9 includes avatars 902-912 of a group of users at a virtual beach social event. The group activity system has provided instructions for an activity for a goal of as many users' avatars as possible holding hands. The users in control of avatars 902-908 have controlled them to have their hands touching. The group activity system tracks these activities and, in response, provides an increasing amount of emojis, such as emojis 914a-914c, as the amount of avatars touching hands increases.

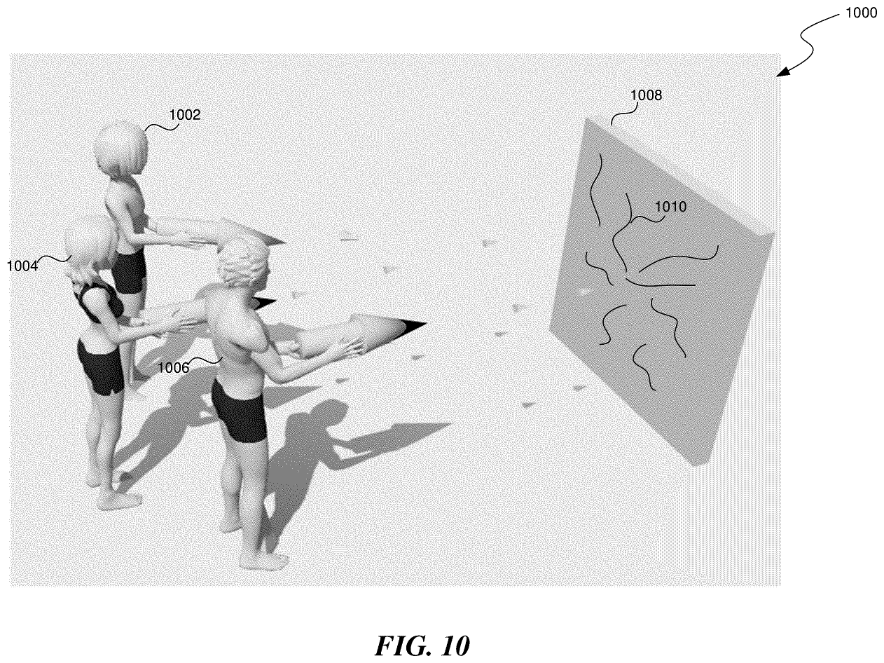

FIG. 10 is a conceptual diagram of an example 1000 of a second collaborative artificial reality group activity. FIG. 10 includes avatars 1002-1006 of a group of users at a virtual beach social event. The group activity system has provided instructions for a collaborative activity with a goal of breaking through a wall 1008. The users in control of avatars 1002-1006 have controlled them to point shooters at a wall 1008. The group activity system tracks these activities and, in response to virtual projectiles striking the wall 1008, provides crack lines 1010, indicating an amount of damage to the wall 1008.

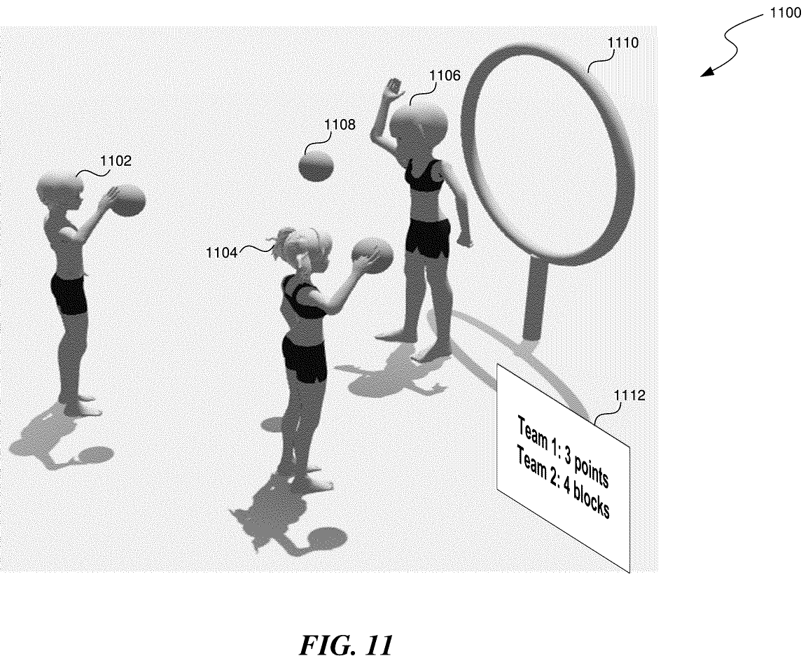

FIG. 11 is a conceptual diagram of an example 1100 of a competitive artificial reality group activity. FIG. 11 includes avatars 1102-1106 of a group of users at a virtual beach social event. The group activity system has divided the users into two teams with avatars 1102 and 1104 on a first team and avatar 1106 on a second team, has instructed the first team to attempt throwing balls (e.g., ball 1108) through ring 1110, and has instructed the second team to attempt blocking the balls from passing through the ring 1110. The group activity system tracks these activities and, in response to a ball being thrown but not going through the ring, increases the points for the second team by one and in in response to a ball being thrown and going through the ring, increases the points for the first team by one. The group activity system provides a running score for the two teams in scoreboard 1112.

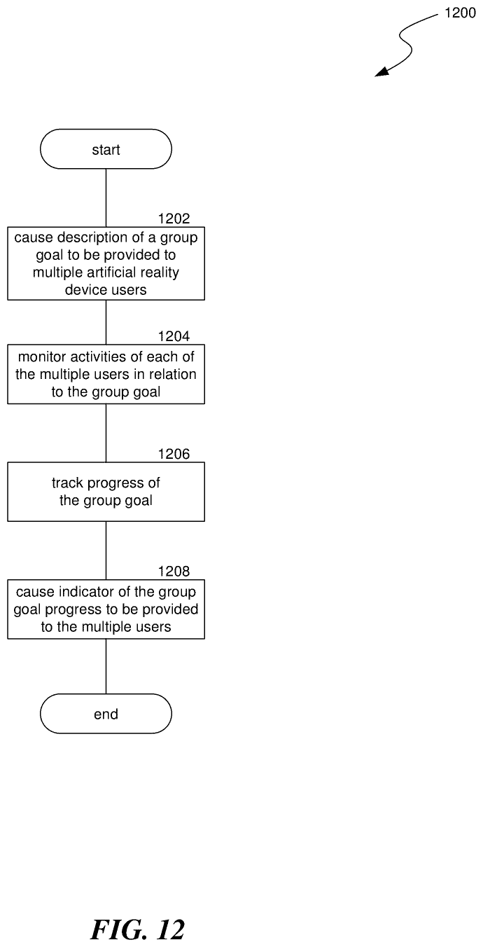

FIG. 12 is a flow diagram illustrating a process 1200 used in some implementations for providing activities with a common goal to a group of users in artificial reality. In some implementations, process 1200 can be performed on a server system, e.g., coordinating the activities of an artificial reality environment for multiple users. In other implementations, instances of process 1200 can be performed on client systems, coordinating the activities of multiple users in the artificial reality environment. In various cases, process 1200 can be performed as part of a virtual experience, e.g., as users attend virtual events, such as at a defined time (e.g., half-time in a sporting event) or in response to detected events (e.g., when a group energy level indicator exceeds a threshold or when a threshold number of users join an event).

At block 1202, process 1200 can cause a description of a group goal to be provided to multiple users via their artificial reality devices. In various implementations, the group goal can be a collaborative goal, a team goal, or an individual goal. For example, process 1200 can provide a collaborative goal of as many avatars as possible holding hands, doing “the wave,” creating a human pyramid, performing synchronized dancing, creating a ribbon chain, etc. As further examples, process 1200 can divide the users into teams and provide a competitive goal each team achieving an objective more than the other team, being the first to achieve an objective, etc. In some cases, when process 1200 sets the goal, users can opt in or out of participating, e.g., though an explicit response or by beginning or not beginning to perform a corresponding activity.

At block 1204, process 1200 can monitor activities of each of the multiple users in relation to the group goal. In some cases, the group activity can define certain user or avatar actions (either individually or as interactions between avatars and/or virtual objects) that correspond to progressing the goal. In various implementations, these activities can be monitored by process 1200 by tracking how users: control avatars to mirror their real-world actions (i.e., “puppeting” their avatars), provide voice commands, provide inputs to a controller, mouse, touchscreen or other computing I/O device, perform command gestures, or other types of inputs.

At block 1206, process 1200 can, based on the monitored activities, track progress of the group goal. Process 1200 can accomplish this by applying one or more rules, defined for the group activity, to the activities monitored at block 1204. These rules can define mappings from detected user activities, individually or as collaborative acts, to progress in the group goal. In various implementations, these rules can define how actions in relation to other avatars, the artificial reality environment, or virtual objects cause changes in the progress of the goal. For example, a rule can define that a team gets a point when a member of that team fires a projectile which collides with a particular NPC. As another example, a rule can define that the overall group score can increase for each additional avatar that joins a group activity of dancing in unison. As yet another example, a rule can define that a trigger occurs (to be used at block 1208) when a threshold amount of users join a group activity, such as holding up virtual lighters at a virtual concert.

At block 1208, process 1200 can cause an indicator of the progress of the group goal to be provided to the multiple users. The progress indicator can be in various forms such as a visual score indicator, an audible signal such as a voice recording or sound effect, a haptic feedback to users' artificial reality devices, etc. In some implementations, various triggers that occur at block 1206 (e.g., when threshold amounts of users perform a communal action, etc.) can be mapped to a corresponding output at block 1208. For example, when a threshold number of fans at a virtual sporting event all perform the wave together, virtual fireworks can be triggered in the sky.

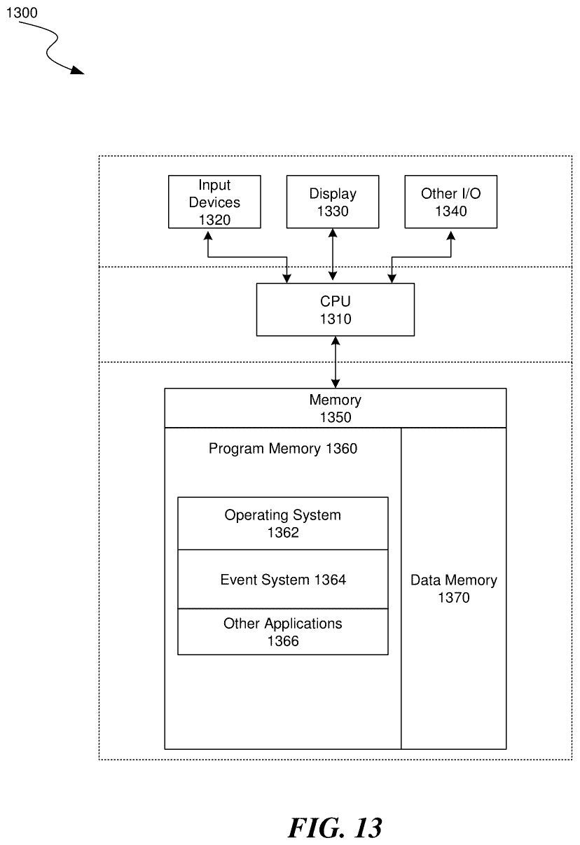

FIG. 13 is a block diagram illustrating an overview of devices on which some implementations of the disclosed technology can operate. The devices can comprise hardware components of a device 1300 as shown and described herein. Device 1300 can include one or more input devices 1320 that provide input to the Processor(s) 1310 (e.g., CPU(s), GPU(s), HPU(s), etc.), notifying it of actions. The actions can be mediated by a hardware controller that interprets the signals received from the input device and communicates the information to the processors 1310 using a communication protocol. Input devices 1320 include, for example, a mouse, a keyboard, a touchscreen, an infrared sensor, a touchpad, a wearable input device, a camera- or image-based input device, a microphone, or other user input devices.

Processors 1310 can be a single processing unit or multiple processing units in a device or distributed across multiple devices. Processors 1310 can be coupled to other hardware devices, for example, with the use of a bus, such as a PCI bus or SCSI bus. The processors 1310 can communicate with a hardware controller for devices, such as for a display 1330. Display 1330 can be used to display text and graphics. In some implementations, display 1330 provides graphical and textual visual feedback to a user. In some implementations, display 1330 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1340 can also be coupled to the processor, such as a network card, video card, audio card, USB, firewire or other external device, camera, printer, speakers, CD-ROM drive, DVD drive, disk drive, or Blu-Ray device.

In some implementations, the device 1300 also includes a communication device capable of communicating wirelessly or wire-based with a network node. The communication device can communicate with another device or a server through a network using, for example, TCP/IP protocols. Device 1300 can utilize the communication device to distribute operations across multiple network devices.

The processors 1310 can have access to a memory 1350 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1350 can include program memory 1360 that stores programs and software, such as an operating system 1362, event system 1364, and other application programs 1366. Memory 1350 can also include data memory 1370, which can be provided to the program memory 1360 or any element of the device 1300.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

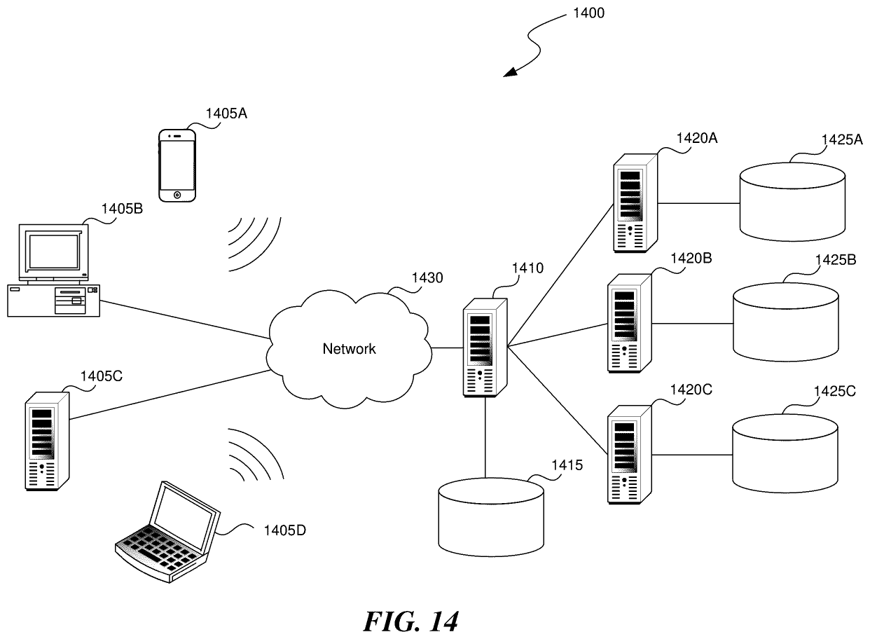

FIG. 14 is a block diagram illustrating an overview of an environment 1400 in which some implementations of the disclosed technology can operate. Environment 1400 can include one or more client computing devices 1405A-D, examples of which can include device 1300. Client computing devices 1405 can operate in a networked environment using logical connections through network 1430 to one or more remote computers, such as a server computing device.

In some implementations, server 1410 can be an edge server which receives client requests and coordinates fulfillment of those requests through other servers, such as servers 1420A-C. Server computing devices 1410 and 1420 can comprise computing systems, such as device 1300. Though each server computing device 1410 and 1420 is displayed logically as a single server, server computing devices can each be a distributed computing environment encompassing multiple computing devices located at the same or at geographically disparate physical locations. In some implementations, each server 1420 corresponds to a group of servers.

Client computing devices 1405 and server computing devices 1410 and 1420 can each act as a server or client to other server/client devices. Server 1410 can connect to a database 1415. Servers 1420A-C can each connect to a corresponding database 1425A-C. As discussed above, each server 1420 can correspond to a group of servers, and each of these servers can share a database or can have their own database. Databases 1415 and 1425 can warehouse (e.g., store) information. Though databases 1415 and 1425 are displayed logically as single units, databases 1415 and 1425 can each be a distributed computing environment encompassing multiple computing devices, can be located within their corresponding server, or can be located at the same or at geographically disparate physical locations.

Network 1430 can be a local area network (LAN) or a wide area network (WAN), but can also be other wired or wireless networks. Network 1430 may be the Internet or some other public or private network. Client computing devices 1405 can be connected to network 1430 through a network interface, such as by wired or wireless communication. While the connections between server 1410 and servers 1420 are shown as separate connections, these connections can be any kind of local, wide area, wired, or wireless network, including network 1430 or a separate public or private network.

In some implementations, servers 1410 and 1420 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users, For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected, For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021 and now issued as U.S. Pat. No. 11,402,964 on Aug. 2, 2022, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/we claim:

1. A method for implementing dynamic presentation controls in a virtual reality environment, the method comprising:
detecting a trigger in a presentation; and
in response to detecting the trigger, immediately initiating a corresponding event within the presentation to make a pre-configured world change within the virtual reality environment.

2. A method for providing customizations in response to a determined state of a group participating in an artificial reality environment activity, the method comprising:
detecting a state of the group in the artificial reality environment;
determining that the detected state corresponds to an artificial reality environment customization; and
executing a rule that implements the customization corresponding to the detected state.

3. A method for providing artificial reality group activities, the method comprising:
causing a description of a group goal to be provided to multiple users via their artificial reality devices;
monitoring activities of each of the multiple users in relation to the group goal;
based on the monitored activities, tracking progress of the group goal; and
causing an indicator of the progress of the group goal to be provided to at least some of the multiple users.
